(19) United States
(12) Patent Application Publication
(10) Pub. No.: US 2026/0117007 A1
(43) Pub. Date: Apr. 30, 2026

(54) Synthetic Binder for Use in Paving, Soil Stabilization, and Waterproofing, and Method for Preparing the Same

(71) Applicant: LIGANUS Corp, Plantation, FL (US)

(72) Inventors: Jorge Ariel Mora, Buenos Aires (AR); Victor Amin Madcur, Buenos Aires (AR); Roberto Oscar Vivas, Buenos Aires (AR)

(21) Appl. No.: 18/932,339

(22) Filed: Oct. 30, 2024

(51) Int. Cl. C08F 212/08

(52) U.S. Cl. CPC C08F 212/08

(57) ABSTRACT

A synthetic binder for use in road paving, soil stabilization, and waterproofing, comprises a mixture of an A-E (acrylic-styrene) copolymer, with modified monomers in its proportion, and an amine-type adhesion enhancer. The synthetic binder may include a copolymer of the AE type (acrylic-styrene) with 25-50% butyl acrylate (C7H12O2), 25-50% 2-ethylhexyl acrylate (C11H20O2), and 25-75% styrene (C8H8), plus 0.5-1.5% acrylic acid (C3H4O2). The mixture may be emulsified in water at 50%, and then introduced into a polymerization reactor.

### TECHNICAL FIELD

The present invention relates to a high-performance synthetic binder designed for application in the paving of public roads, streets, pedestrian pathways, decorative areas, soil stabilization, and waterproofing. This binder is prepared from a mixture of a copolymer and an amine-based adhesion promoter.

The purpose of this binder is to produce a composite material consisting of the binder and aggregates of various sizes and mineral origin, which, when applied over a sub-base and base, has the ability to withstand the weight and frequency of traffic while meeting all safety standards, preventing deformations and cracking, and ensuring long-term durability under various climatic conditions.

### BACKGROUND

Currently, the vast majority of road pavements are constructed using a mixture of mineral aggregates, commonly referred to as gravel, and bituminous asphalt, which acts as a binder. Although bitumen is a minor component of the pavement, its performance largely depends on it, as it is the only deformable element. Bitumen is typically obtained through the vacuum distillation of crude oil.

There is an increasing need for pavements with enhanced mechanical properties, designed to prevent aging processes at high temperatures, such as permanent deformation in the form of rutting, and fractures at low temperatures. Modern paving needs increasingly demand binders with higher mechanical performance than conventional bitumen.

To date, significant advances have been made in the development of synthetic binders with properties comparable to those of bitumens obtained from the vacuum distillation of crude oil. The physical and elastomeric characteristics that define the specific application of the obtained product are mainly penetration, viscosity, brittleness, low-temperature ductility, elastic recovery, and tensile strength, among others. It is well known that conventional bitumen, obtained from heavy fractions of petroleum distillation, does not simultaneously exhibit all the qualities currently required for use as binders in mixtures with aggregates. It is also known that the addition of certain types of polymers improves their mechanical properties, which is essential when used for road construction. The polymers that can be added are mostly elastomers, such as butyl rubber, polybutene, EVA copolymers, and ethylene/propylene/conjugated diene terpolymers (EPDM), as well as well-known styrene and conjugated diene statistical or block copolymers (thermoplastic elastomers)

It is well established that the use of bitumen-modifying additives, particularly polymers, generally improves the mechanical properties of the binder, reducing the effect of temperature and increasing resistance to permanent deformation and fracture. Thermoplastic polymers, such as high- and low-density polyethylene, polypropylene, ethylene-vinyl acetate copolymers, ethylene-propylene copolymers, and styrene-butadiene-styrene, have been mixed with bitumen to improve the performance of road pavements.

In the design of synthetic binders for applications such as waterproofing, soil stabilization, and paving, it is crucial to understand the properties of the substances that make up the resulting mixture. Not only is it important to characterize the raw materials, but it is also necessary to describe the behavior of the mixtures derived from them to predict the performance of the overall blend.

Significant progress has been made in developing synthetic binders with properties comparable to bitumen derived from vacuum distillation of crude oil. However, the use of synthetic binders in mixtures with aggregates for road pavement construction has not yet been described in the literature.

Asphalt bitumens are defined as hydrocarbon binders prepared from natural hydrocarbons that contain a low proportion of volatile products, have characteristic binding properties, and are essentially soluble in carbon disulfide. They are classified according to the minimum and maximum allowable penetration values, according to NLT-124. Asphalt bitumen used for road applications must meet the specifications for types B13/42, B40/50, B60/70, B80/100, B150/200, and B200/300.

The SHRP protocol was established by the U.S. Congress in 1987 to improve highway performance and durability, making them safer for users. As a result, SUPERPAVE® emerged, a product of SHRP research on asphalt, which integrates performance-based asphalt specifications, testing methods, equipment, and protocols.

This protocol was designed for hot asphalt mixtures. Therefore, in our case, with a synthetic binder, not all its recommendations apply since we are dealing with an emulsion prepared and applied in the mixture with aggregates at temperatures ranging from 0° C. to +90° C.

Traditional tests like penetration or viscosity are not adequately correlated with the performance and behavior of pavement. The primary objective of the SHRP protocol was to develop performance-based specifications for hot-applied bitumen and modified bitumen.

SUPERPAVE introduced a new performance-based grading system called the “Performance Grade” (PG), which was adopted by AASHTO (American Association of State Highway and Transportation Officials) as MP1. This system is based on both the maximum average pavement temperature over a seven-day period and the minimum temperature the pavement experiences. One example is PG 64-28 bitumen. The first number indicates that the bitumen is suitable for temperatures up to 64° C., while the second number indicates that it will perform adequately down to a minimum value of −28° C.

As a result of research conducted under the SHRP protocol, new methods for characterizing bitumen and modified bitumen were developed. These methods allow the correlation of laboratory-scale results with the appropriate service temperatures:
1. Dynamic Shear Rheometry (DSR) for high temperatures
2. Bending Beam Rheometry (BBR) for low-temperature zones.

Through oscillatory shear rheometry, rheological properties like the complex shear modulus (G*) and the phase angle (δ) are measured over a temperature range of 0 to 90° C., according to AASHTO TP5. Per the specifications in AASHTO MP1, certain values must be achieved for the test temperature to be considered the maximum grading temperature for bitumen. The tests are conducted on both unaged and aged samples:

G*/sin(δ)>1.0 kPa G*/sin(δ)>2.2 kPa

G*sin(δ)<5000 kPa

It is important to highlight that, in the case of the polymeric binder, an aged state in RTFOT was not evaluated, and it is not necessary to do, since the one described in this disclosure is used cold and does not undergo aging as occurs with asphalt binders in the process of producing hot asphalt mixtures.

To be considered suitable for paving, according to AASHTO MP1, the viscosity of unaged bitumen or modified bitumen, measured at 135° C. (ASTM D4402-87), should not exceed 3 Pa*sec.

In our case, the synthetic binder described in this disclosure does not apply this previous condition as it is used at a temperature range of 0° C. to +90° C.

The characteristics to improve compared to traditional bitumen are flexibility at low service temperatures (<5° C.), elasticity or viscosity at high service temperatures (>50° C.). However, it must maintain ease of processing and manageability during pavement construction, and consequently, the viscosity values at these temperatures (135-165° C.) are NOT necessary for this cold-applied binder.

Embodiments of this invention include a binder made with a novel formulation of polymers, which, when mixed with aggregates, primarily results in concrete or pavement for road use.

The formulation of the synthetic binder, which is the subject of some embodiments of this invention, is a copolymer of the AE (acrylic-styrene) type with a percentage of butyl acrylate (C7H12O2), ethyl hexyl acrylate (C11H20O2), and styrene (C8H8), and finally a low percentage of acrylic acid (C3H4O2). This mixture is emulsified in water and is then introduced into a polymerization reactor.

This development is the result of research into the combination of polymeric binders and the dosage of these within the mixture with aggregates.

The inventors herein have found that modifying the proportion of the monomers in an A-E (acrylic-styrene) copolymer and adding an amine-based adhesion promoter leads to the generation of a synthetic binder with an adequate physical and elastomeric profile for application in waterproofing, soil stabilization, and road paving.

The components involved in the concrete are as follows:

### 1. Aggregates:

The aggregates meet the quality standards set by the relevant road authority (in Argentina, standard DNV 98), including granulometric curve requirements and other specifications such as the Los Angeles abrasion test.

### 2. Polymeric Binder:

It is a combination of polymers that results in a cohesive mass capable of withstanding road traffic demands and passing the following tests: Apparent Density (IRAM 6845-2), Marshall Stability and Flow (IRAM 6845-6), Moisture Susceptibility Test—LOTTMAN (AASHTO T-283), Wheel Tracking Test (IRAM 6850), Resilient Modulus (EN 12697:26) at 20° C., 2 Hz, Fatigue Resistance (EN 12697-24)—Four-Point Bending Test on Prismatic Specimens, and Rheological Tests such as Penetration (IRAM 6576), Rheological Properties of the Asphalt Binder DSR (AASHTO T-315), and “Multiple Stress Creep Recovery” MSCR (AASHTO T-350). The polymers include an emulsion of the polymer itself (acrylic, styrene, or vinyl) in water.

### 3. Dosage of the Polymeric Binder:

The dosage results from meeting the minimum technical requirements of the relevant standards while minimizing the economic impact on the cost of the resulting concrete.

### SUMMARY

A synthetic binder for use in road paving, soil stabilization, and waterproofing that comprises a mixture of an A-E (acrylic-styrene) copolymer, with modified monomers in its proportion, including 25-50% butyl acrylate (C7H12O2), 25-50% 2-ethylhexyl acrylate (C11H20O2), and 25-75% styrene (C8H8), plus 0.5-1.5% acrylic acid (C3H4O2). This mixture is emulsified in water at 50% and then introduced into a polymerization reactor. An amine-type adhesion enhancer, Aziridine (an ethylene imine) (CH2)2NH, is added in a proportion of 0.05% diluted in water, and the components are mixed mechanically. In a specific embodiment, the binder comprises 99.95% A-E copolymer and 0.05% amine adhesion enhancer.

### BRIEF DESCRIPTION OF THE DRAWINGS

The objectives and features of the invention will become more readily apparent from the following detailed description taken in conjunction with the accompanying drawings in which:

FIG. 1 shows a resulting gradation curve.

FIG. 2 shows a results curve with the mean value of tests.

FIG. 3 shows the fatigue failure behavior of a tested material in accordance with an embodiment of the invention.

FIG. 4 is a graph showing rheological properties of a tested material sample in accordance with an embodiment of the invention.

FIG. 5 is another graph showing additional rheological properties of a tested material sample in accordance with an embodiment of the invention.

FIG. 6 is a schematic representation of offset positions for which determinations were made during testing.

FIG. 7 is a graphical representation of the progression of the dynamic modulus over the days of testing of a material in accordance with one embodiment of the invention.

FIG. 8 is a schematic representation similar to FIG. 6.

FIG. 9 shows a pair of master curves illustrating the behavior of a tested material in accordance with one embodiment of the invention.

### DETAILED DESCRIPTION OF PARTICULAR EMBODIMENTS

Surprisingly, the inventors herein have found that by modifying the proportion of monomers in an A-E (acrylic-styrene) copolymer and adding an amine-based adhesion promoter, a synthetic binder is generated with a physical and elastomeric profile suitable for waterproofing, soil stabilization, and public road paving.

Thus, the first aspect of this disclosure refers to a synthetic binder that contains a mixture of a copolymer and an amine-based adhesion promoter. The copolymer provides cohesiveness, consistency, elasticity, and tensile strength, while the amine component improves adhesion to the inert phase or aggregate of the pavement. By modifying the proportions of the monomers in the A-E (acrylic-styrene) copolymer, which yields different rheological properties with varying glass transition temperatures, within a range of −25° C. to +35° C., it is possible to design binders with similar or enhanced properties to commercial bitumen, such as different grades of penetration.

Fox and Flory found that the best desirable tensile strength characteristics are achieved by using a monomer composed of a branch with a hexyl radical, which imparts to the resulting polymer the most suitable tensile strength parameters and glass transition temperature for use in embodiments of the present invention.

The formulation of the synthetic binder includes or consists of an AE (acrylic-styrene) copolymer containing 25-50% butyl acrylate (C7H12O2), 25-50% 2-ethylhexyl acrylate (C11H20O2), and a 25-75% styrene (C8H8), plus 0.5-1.5% acrylic acid (C3H4O2), this mixture is emulsified in water at 50% concentration and then introduced into a polymerization reactor.

For the preparation of the synthetic binder's first component, the AE copolymer, the mixture of monomers mentioned above is injected into a batch or continuous reactor. Before injection, the monomers are preheated to a temperature between 60° C. and 85° C., preferably 70° C. to 75° C., and emulsified in water using a non-ionic surfactant agent-nonylphenol 10 moles (C15H24O). Additionally, potassium persulfate (KPS, K2S2O8) is added as a polymerization initiator at a proportion of 0.01% to 0.1% of the monomers' weight, for example between 0.07% and 0.1%. The reaction is carried out under constant agitation using an anchor-type stirrer at a rotation speed of 60 rpm to 300 rpm, preferably around 150 rpm.

The reaction is maintained for 1.5 to 3 hours and is stopped by reducing the temperature to 20° C. and neutralizing the mixture with sodium hydroxide (NaOH) in a 10% aqueous solution. The formation of lumps during the process is controlled by adjusting the temperature, preferably by adding an initial polymer as a seed in proportions ranging from 0.1% to 0.5%.

To the copolymer, a second component is added: an amine-based adhesion promoter, specifically aziridine (an ethyleneimine) (CH2)2NH in a proportion of 0.05% diluted in water.

For the preparation of the final formulation the raw materials are introduced into a mixing device in the following proportions and order:
1. Between 99-99.9% by weight of the A-E copolymer.
2. Between 0.1-1% by weight of the amine-based adhesion promoter.

In one embodiment, the binder comprises 99.95% A-E copolymer and 0.05% amine-based adhesion promoter.

For the synthetic binder, it is initially prepared with the A-E copolymer and is then mechanically mixed with the amine-based adhesion promoter at room temperature, between 0° C. and 50° C. The mixing time ranges from 3 to 5 minutes, with an agitation speed between 60-300 rpm.

The final mixing process can be carried out discontinuously, in batch mode.

### Tests Conducted on an Example Implementation

For experts in the field, the advantages and characteristics of the embodiments in the present disclosure become evident from the following tests conducted:
A—Rheological Analysis of the Synthetic Polymer Binder

After processing, the samples underwent two key rheological tests. First, a penetration test was performed on the binder. Additionally, a dynamic shear rheometer (DSR) was used to measure the parameter G/sin δ* at various temperatures, which is utilized in the AASHTO M320/ASTM D7175 standards to determine the Performance Grade (PG) for high-temperature conditions. The DSR also provided measurements for Creep Compliance (Jnr) and Elastic Recovery Percentage (R) at 76° C., under different stress levels (0.1 kPa, 3.2 kPa), as defined in AASHTO M332. These parameters help determine the high-temperature PG rating based on the Multiple Stress Creep Recovery (MSCR) test.

From the dynamic response of the material, two key values were derived: the storage modulus (G′) and the loss modulus (G″), which are indicative of the elastic and viscous behavior of the binder, respectively. This test replicates traffic conditions for a speed of 90 km/h. The complex shear modulus (G)* and phase angle are essential for predicting and preventing deformation and other issues that may arise in asphalt mixtures under traffic loads. For instance, the permanent deformation of asphalt mixtures is correlated with the elastic component of the complex modulus, G*cos (δ).

For this reason, the Superpave program specifies a minimum value for this elastic component to prevent permanent deformation of the asphalt mixture. On the other hand, another phenomenon, such as fatigue cracking, is linked to the value of the viscous component of the complex modulus, G*sin (Angle). In this case, the Superpave program specifies a maximum value for this viscous component to avoid fatigue cracking.

### Rheological Properties of the Polymer Binder (DSR) AASHTO T-315

Some of these results are presented and compared with the limits of the AASHTO M320 specifications for both virgin and aged asphalt in RTFOT. It is observed that the acrylic-styrene polymer exhibits values significantly higher than the limits of AASHTO M320, which are 1 and 2.2 kPa for the original and aged states of the binders. It is worth noting that in the case of the acrylic-styrene polymer, an aged state in RTFOT was not evaluated, and it is unnecessary to do so, as it is used cold and does not undergo aging like asphalt binders do in the process of producing hot asphalt mixtures.

### Multiple Stress Creep Recovery MSCR (AASHTO T-350)

It is noteworthy that this test is typically conducted on asphalt binder aged in RTFOT and at the temperature that meets the G/sen□≥2.2 kPa of the classification of AASHTO M320. The acrylic-styrene polymer binder is not aged in RTFOT for the reasons mentioned earlier. Furthermore, since this polymer binder exhibits values greater than 2.2 kPa for the entire range of temperatures studied, even at 88° C., the MSCR parameters were determined at 76° C. This is one of the highest temperatures that can be found on asphalt pavements. The objective is to observe the elastic and resistant capacity of the acrylic-styrene polymer binder at these high temperatures. The data show the high elasticity and stiffness of the binder at this temperature, even under the stress changes applied in the test.

On the other hand, pavements with an example of the synthetic polymer binder described in this disclosure were tested, namely
B—Characterization and laboratory tests of Marshall mechanical and volumetric parameters of pavements with synthetic polymer binder.
C—Performance tests of pavements with synthetic polymer binder in the laboratory, such as:
C-1: Moisture damage (AASHTO T283-IRAM6846-2).
C-2: Fatigue at (f=10 Hz T=20° C. 100 ms (EN12697-24).
C-3: Wheel Tracking Test (IRAM 6850-EN126897-22).
C-4: Cracking. Dynamic modulus test-Frequency sweep at three temperatures (EN12697-26 Annex C).
C-5: Indirect tensile test at 5 and 25° C. (IRAM6846-1).
D—Performance tests of pavements with synthetic polymer binder in witness sections, by indicators of surface deterioration, such as:
D-1: Rutting
D-2: Cracking
D-3: Friction
D-4: Irregularity
E—Practice of the embodiments of the invention

### B) Test XXII-109 Marshall-Lottman-WTT-1 Tests on Asphalt Mixture

| No. of | | | | Date | Date of |
|---|---|---|---|---|---|
| Sample | | | | sample | sample |
| Entry | Material | Brand | Origin | was taken | entry |
| 30248 | Gravel 6-19 | — | DMT S.A. | — | Mar. 2, 2022 |
| 30249 | Sand 0-6 | — | DMT S.A. | — | Mar. 2, 2022 |
| 30247 | Pebble | — | DMT S.A. | — | Mar. 2, 2022 |
| 30245 | DJRA polymer | — | DMT S.A. | — | Mar. 2, 2022 |

Tests to be Run in the UIDIC on the Mixture with Styrene Acrylic Polymeric Binder

| Asphalt | |
|---|---|
| Mixture | Tests to make |
| STYRENE | Apparent density (IRAM 6845-2) |
| ACRYLIC | Rice Density and % of Empties |
| POLYMERIC | (IRAM 6845-3/ 6845-4) |
| MIXTURE | Stability and Marshal Fluency |
| CACD19 | (IRAM 6845-6) |
| | Moisture susceptibility test - |
| | LOTTMAN (AASHTO T-283) |
| | Wheel Tracking Test (IRAM 6850) |

The verification of the volumetric and mechanical parameters of the Marshall test was carried out, considering the material proportions and resulting gradation proposed by the client, with minor corrections. In this context, the results are reported with the resulting gradation (Centered) containing 4.8% styrene-acrylic polymer, molded cold in accordance with the guidelines set by the client since it is a non-conventional product (i.e., not an asphalt binder). The results obtained from the tests, considering the gradation within its tolerance, are identified in this report as CAC D19 mix with styrene-acrylic polymer.

The verification of the volumetric and mechanical parameters of the Marshall test was carried out, considering the material proportions and resulting gradation proposed by the client, with minor corrections. In this context, the results are reported with the resulting gradation (Centered) containing 4.8% styrene-acrylic polymer, molded cold in accordance with the guidelines set by the client since it is a non-conventional product (i.e., not an asphalt binder). The results obtained from the tests, considering the gradation within its tolerance, are identified in this report as CAC D19 mix with styrene-acrylic polymer.

Asphalt Mixture Base Type CAC D19 with CA 30

### Aggregate Dosing

PERCENTAGE OF WEIGHT IN AGGREGATES

| AGGREGATE Gravel 6-19 | AGGREGATE 0-6 | GRAVEL |
|---|---|---|
| Sample No. 30248 | Sample No. 30249 | Sample No. 30247 |
| 42.0 | 55.0 | 3.0 |

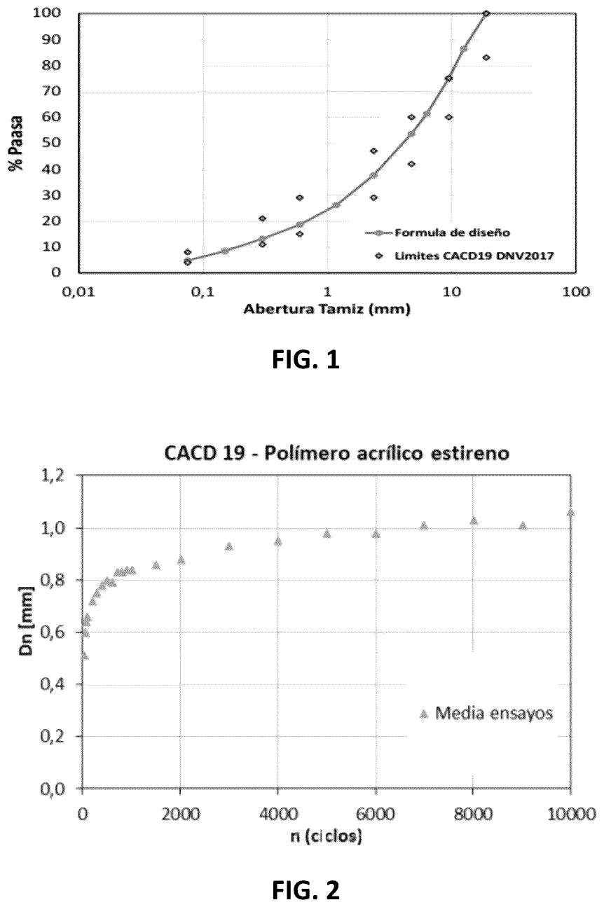

The resulting gradation curve obtained with this mixture is presented in the table below and FIG. 1:

| | SIEVES | | | | | | | | | |
|---|---|---|---|---|---|---|---|---|---|---|
| | 1″ | ¾″ | ½″ | ⅜″ | ¼″ | No. 4 | No. 8 | No. 30 | No. 50 | No. 200 |
| | (25.0 mm) | (19.0 mm) | (12.5 mm) | (9.5 mm) | (6.35 mm) | (4.75 mm) | (2.36 mm) | (600 um) | (300 um) | (75 um) |
| Cumulative | 100 | 100 | 86.3 | 75.0 | 61.3 | 56.3 | 37.6 | 18.6 | 13.2 | 4.8 |
| passings/ | | | | | | | | | | |
| UIDIC | | | | | | | | | | |
| [%] | | | | | | | | | | |
| DNV | | 100 | 100-83- | 75-60 | — | 60-42 | 47-29 | 29-15 | 21-11 | 8-4 |
| Spindle | | | | | | | | | | |
| 2017 | | | | | | | | | | |

This gradation was the one used. The samples were cold molded according to the guidelines requested by the client, with a total of 4.8% of the styrene acrylic polymer binder.

### Test Report

### Volumetric Parameters

### Bulk Density—Rice Density—Air Voids

### I. Sampling, Identification, Reception and Characterization of the Sample.

Date of sample collection: ______/______/______
Sampling location: ______
Sampling procedure: See Note 1
Identification of sampling: CAC D19 mixture with styrene acrylic polymer
Sampling entry date: Mar. 2, 2022

### Internal Laboratory No.:

### II. Test

Samples were molded with 4.8% of the product according to the guidelines provided by the client, resulting in the following outcomes.

Date of sampling execution: Jul. 20, 2022.

| MOLDING TEMPERATURE: Cold | No. OF STRIKES PER FACE: 75 | | |
|---|---|---|---|
| No. of TEST TUBE | 1 | 2 | 3 |

APARENT DENSITY IRAM 6845-2

| | | | |
|---|---|---|---|
| APPARENT DENSITY (Da) [g/cm³] | 2.489 | 2.493 | 2.491 |

| | |
|---|---|
| MEDIUM DENSITY [g/cm³] | 2.491 |
| GEOMETRIC MEAN | 2.491 |
| STANDARD DEVIATION | 0.002 |
| VARIATION COEFICIENT | 0.07 |

MAXIMUM DENSITY MEASURED (RICE)
IRAM 6845-3 / IRAM 6845-4
TEMPERATURE OF THE WATER 25° C. +/− 0.5° C.

| | | |
|---|---|---|
| RICE (Dr) [g/cm³] | 2.693 | 2.693 |

| MEDIUM RICE(Dr) [g/cm³] | 2.693 | | |
|---|---|---|---|
| INDIVIDUAL AIR VOIDS [%] | 7.6 | 7.4 | 7.5 |

| | |
|---|---|
| MEDIUM AIR VOIDS [%] | 7.5 |
| GEOMETRIC MEAN | 7.5 |
| STANDARD DEVIATION | 0.07 |
| VARIATION COEFFICIENT | 0.91 |

Observations: The mixtures were prepared following the molding guidelines and the proportions provided by the client. Some adjustments were made by UIDIC in the design. Certain characteristics differ from traditional ones due to the nature of the binder under study, as this is not an asphalt mixture per se.

### Test Report: Mechanical Parameters-Marshall Test

### I. Sampling, Identification, Reception and Characterization of the Sample.

Date of sample collection: ______/______/______
Sampling location: ______
Sampling procedure: See Note 1
Identification of sampling: CACD19 mixture with styrene acrylic polymer
Sampling entry date: Mar. 2, 2022

### Internal Laboratory No.:

### II. Test

Date of sample execution: Mar. 18, 2022

| MOLDING TEMPERATURE: Cold | No. OF STRIKES PER FACE: 75 | | |
|---|---|---|---|
| No. of TEST TUBE | 1 | 2 | 3 |

MARSHAL TEST IRAM 6845-5
WATER TEMPERATURE 60° C. +/− 0.5° C.

| | | | |
|---|---|---|---|
| Marshal Stability [kN] | 10.9 | 10.9 | 11.4 |

| | |
|---|---|
| AVERAGE STABILITY [kN] | 11.0 |
| GEOMETRIC MEAN [kN] | 11.0 |
| STANDARD DEVIATION [kN] | 0.28 |
| VARIATION COEFICIENT [%] | 2.56 |

| | | | |
|---|---|---|---|
| Fluency [mm] | 3.3 | 3.1 | 3.1 |

| | |
|---|---|
| AVERAGE FLUENCY [mm] | 3.2 |
| GEOMETRIC MEAN [mm] | 3.2 |
| STANDARD DEVIATION [mm] | 0.12 |
| VARIATION COEFFICIENT [%] | 3.65 |

| | | | |
|---|---|---|---|
| Stability/ Fluency Relationship | 3.30 | 3.51 | 3.67 |
| [kN/mm] | | | |

| | |
|---|---|
| EST./FL AVERAGE | 3.5 |
| RELATIONSHIP | |
| GEOMETRIC MEAN [kN/mm] | 3.5 |
| STANDARD DEVIATION [kN/mm] | 0.19 |
| VARIATION COEFFICIENT [%] | 5.32 |

Observations: The mixtures were prepared following the molding guidelines and the proportions provided by the client. Some corrections were made by UIDIC in the design. Certain characteristics differ from traditional ones due to the nature of the binder being studied, as it is not an asphalt mixture per se.

### I. Sampling, Identification, Reception and Characterization of the Sample.

Date of sample collection: ______/______/______
Sampling location: ______
Sampling procedure: See Note 1
Identification of sampling: CACD19 mixture with styrene acrylic polymer
Sampling entry date: Feb. 3, 2022.

### II. Test

Date of sample execution: Jul. 14, 2022

| | MOLDING TEMPERATURE: Cold | | | | | |
|---|---|---|---|---|---|---|
| | No. of strikes per face: 75 | | | | | |
| | No. OF TEST TUBES | | | | | |
| | 1 | 2 | 3 | 4 | 5* | 6 |
| HEIGHT [cm] | 6.16 | 6.44 | 6.36 | 6.2 | 6.16 | 6.19 |
| DIAMETER (cm) | 10.2 | 10.2 | 10.26 | 10.27 | 10.2 | 10.27 |

Test tube five broke and the values could not be determined.

### C-1) Lottman Test

### Moisture Susceptibility Test—Lottman (AASHTO T-283)

### Test Report—Annex CAC II: Effect of Water on the Cohesion of Asphalt Mixtures—Immersion Test—Tensile Strength by Diametral Compression

### I. Sampling, Identification, Reception and Characterization of the Sample.

Date of sample collection: ______/______/______
Sampling location: ______
Sampling procedure: See Note 1
Identification of sampling: CACD19 mixture with styrene acrylic polymer
Sampling entry date: Mar. 2, 2022

### Internal Laboratory No.:

### II. Test

Date of sample execution: Jul. 14, 2022

| | MOLDING TEMPERATURE: Cold | | | | | |
|---|---|---|---|---|---|---|
| | No. of strikes per face: 75 | | | | | |
| | No. OF TEST TUBES | | | | | |
| | 6 | 2 | 3 | 4 | 1 | 6 |
| HEIGHT [cm] | — | 6.44 | 6.36 | 6.2 | 6.16 | 6.19 |
| DIAMETER [cm] | — | 10.2 | 10.26 | 10.27 | 10.2 | 10.27 |

RESISTANCE TO INDIRECT TRACTION

| | 24 h in 60° C. water | | | 24 h in 25° C. oven | | |
|---|---|---|---|---|---|---|
| TEST CONDITION | 2 h in 25° C. water | | | 2 h in 25° C. water | | |
| MAXIMUM BREAKING LOAD [kN] | — | 7.0 | 6.4 | 7.8 | 7.5 | 7.3 |
| RESISTANCE TO INDIRECT | — | 678.8 | 622.2 | 778.5 | 757.2 | 732.7 |
| TRACTION [MPa] | | | | | | |
| RESISTANCE TO AVERAGE | 650.5 | | | 756.2 | | |
| INDIRECT TRACTION [MPa] | | | | | | |

| RETAINED STREGTH INDEX | 116.2 | |
|---|---|---|
| GEOMETRIC MEAN [MPa] | 650.5 | 756.2 |
| STANDARD DEVIATION [MPa] | 28.3 | 18.7 |
| VARIATION COEFFICIENT [MPa] | 4.3 | 2.5 |

Observations: In the case of this specific material, the polymer, and its curing process, RTI (Retained Tensile Index) values increase after the immersion cycle. This is related to a gain in strength of the specimens after the immersion bath, which accelerates the curing process. It is noteworthy that during the tests with the product, a strength gain was observed due to a curing process that can be attributed to the material losing water, which serves as a vehicle for the preparation of the mixtures. This curing process was observed and quantified during the dynamic modulus measurements conducted on the mixture with acrylic styrene polymer, as reported in another test report. Based on these observations, for the Lottman moisture damage test (AASHTO T283), a pre-curing phase was performed in an oven at 40° C. for five days before the immersion cycle. However, the results indicate that the mixture continues to gain strength after the immersion bath. Therefore, this process provides additional curing beyond the initial one. This behavior is specific to this type of mixture and is mainly related to the potential curing, which is unique to these new and unconventional mixtures.

### C2) Wheel Tracking Test

### I. Sampling, Identification, Reception and Characterization of the Sample.

Date of sample collection: ______/______/______
Sampling location: ______
Sampling procedure: See Note 1
Identification of sampling: CACD19 mixture with styrene acrylic polymer
Sampling entry date: Mar. 2, 2022

### Internal Laboratory No.:

### II. Test & Results

Date of sample execution: Apr. 20, 2022
   a. Introduction on the Test

The wheel tracking test widely implemented in various parts of the world began to be used in Argentina in the middle of the former decade. It is an empirical method used to estimate at lab scale the potential capacity of the mixture to resist the deformations a wheel loaded with a weight similar to that of a reglementary load (7 kg/cm²) causes.

The Marshal case on occasion cannot define the proportions of materials and their possible answer or behavior to traffic loads. It has been proven that the mixtures properly made even with rigidities E/FI of 4000 kg/cm, have shown dents on the way. The WTT test complements this methodology.

The causes of this issue are mainly rooted in transit increase both in terms of weight and volume, added to the type of radial wheels and inflation pressure and the employment of binders with lower module rigidity.

The highest denting is caused during the first year of use of the asphalt mixture.

### C3) Wheel Tracking Test

### I. Sampling, Identification, Reception and Characterization of the Sample.

Date of sample collection: ______/______/______
Sampling location: ______
Sampling procedure: See Note 1
Identification of sampling: CACD19 mixture with styrene acrylic polymer
Sampling entry date: Mar. 2, 2022

### Internal Laboratory No.:

### II. Test & Results

Date of sample execution: Apr. 20, 2022
   c—Results

| | | | |
|---|---|---|---|
| | Test | Test | |
| Parameters | Tube 1 | Tube 2 | Average |

c- Denting depth (at 5000 cycles)

| | | | |
|---|---|---|---|
| RD air (d 5000) [mm] | 0.98 | 0.98 | 0.98 |

d- Denting depth (at 10,000 cycles)

| | | | |
|---|---|---|---|
| RD air (d 10000) [mm] | 1.06 | 1.06 | 1.06 |

e. Mean, proportional denting depth (at 10,000 cycles)

| | | | |
|---|---|---|---|
| PRD air [%] | 2.1 | 2.1 | 2.1 |

f.- Fitting curve parameters

A = 0.4361
B = 0.0946

g.- Rutting slope by regression

| | | | |
|---|---|---|---|
| WTS air [mm/10³ cycles] | 0.013 | 0.013 | 0.013 |

### b.—Test Conditions

| | Duration of test: 10.000 cycles | | |
|---|---|---|---|
| Test temperature: 60° C. | Test | Test | |
| Parameter | Tube 1 | Tube 2 | Average |
| b- Data | | | |
| Density [mm] | 51.5 | 51.0 | 51.25 |
| Test Tube density [g/cm³] | 2.490 | 2.492 | 2.491 |
| Marshall Reference | | | 2.491 |
| Density [g/cm3] | | | |
| Maximum theoretical | | | 2.693 |
| density [g/cm3] | | | |
| Air voids [%] | | | 7.5 |
| Compacting [%] | | | 100 |

Results Curve: Mean Value of Tests. See FIG. 2

### C-2) Report XXII-1200 DTM SA Fatigue

### Four-Point Bending Test on Prismatic Samples Standard EN 12697-24

### Internal Reception of Sample

| | | | | | |
|---|---|---|---|---|---|
| Sample | | | | Date of | |
| Entry | | | | sample | Date of |
| Number | Material | Brand | Origin | collection | Sample Entry |

| | | | |
|---|---|---|---|
| 30248 | Gravel 6-19 | DMT S.A. | Mar. 2, 2022 |
| 30249 | Sand 0-6 | DMT S.A. | Mar. 2, 2022 |
| 30247 | Pebble | DMT S.A. | Mar. 2, 2022 |
| 30245 | DJRA | DMT S.A. | Mar. 2, 2022 |
| | Polymer | | |

### Tests to be Conducted on Hot Asphalt Mixture

| Sample | | |
|---|---|---|
| entry | | |
| number | Material | Test to be conducted |
| | Mixture w/ | Resistance to fatigue (EN 12697-24) Flexion |
| | styrene acrylic | test in four points on prismatic test tubes |
| | polymer | |

### I. Sampling, Identification, Reception and Characterization of the Sample.

Date of sample collection: ______/______/2022
Sampling location: ______
Sampling procedure: See Note 1
Identification of sampling: CACD19 mixture with styrene acrylic polymer
   Sampling entry date: Mar. 2, 2022

### Internal Laboratory No.: 26467

### II. Test

Date of sample execution: July 2022

### b.—Test Conditions

Test temperature: 20° C.
Frequency: 10 H
Failure criterion method: 50% initial Stiffness

### c.—Test Execution

| | Initial Dynamic | | Deformation |
|---|---|---|---|
| | Module (MPa) | Cycles | [um/m] |
| V1 | 16060 | 2,003,500 | 100 |
| V4 | 12581 | 15,400 | 200 |
| V3 | 9544 | 2,200 | 300 |

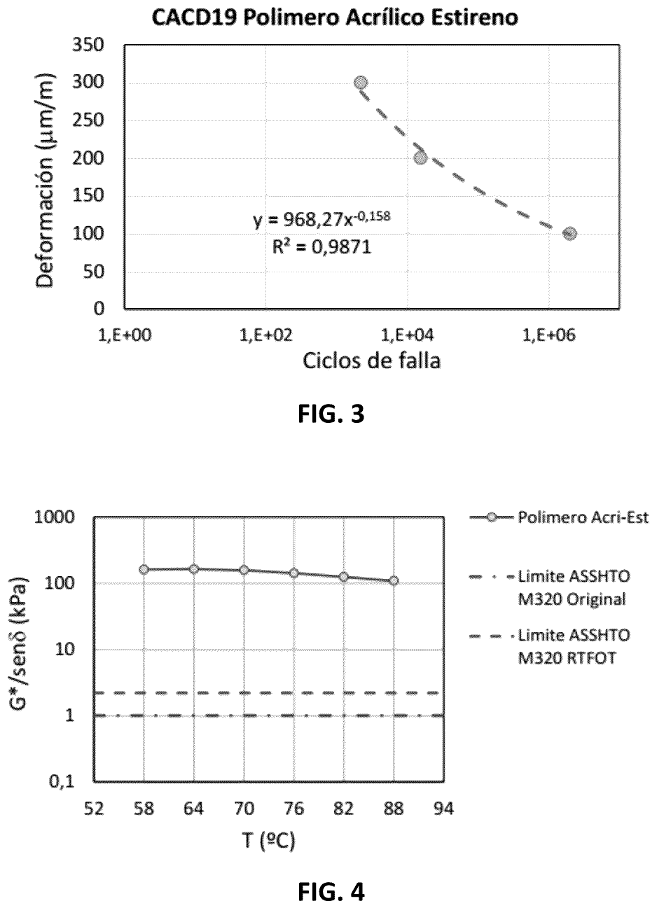

CACD19 Styrene Acrylic Polymer. See FIG. 3

Deformation at 10⁶ cycles=109,14 [μm/m]

y=968.27x^{-0.158} Fatigue line slope:

A test was conducted with 50 μm/m deformation at a frequency of 10 Hz, and the modulus did not drop below 100% for more than 2,000,000 cycles. Under this deformation level, the CACD19 mixture with acrylic styrene polymer binder demonstrated what is known as fatigue endurance, meaning it did not exhibit fatigue failure. Given these conditions, the test was stopped at 2 million cycles.

Additionally, a fatigue test was performed on a beam at 30 Hz frequency, subjected to 90 μm/m deformation, which resulted in a fatigue failure at 444,400 cycles, defined as a 50% reduction from the initial modulus.

### Report XXII-1199 Rheology-Penetration and DSR MSCRT

### Internal Reception of Sample

| No. of | | | | | |
|---|---|---|---|---|---|
| Sample | | | | Date of | Date of |
| Entry | Material | Brand | Origin | sample draw | sample entry |
| 30245 | DJRA | — | DMT S.A. | — | Feb. 2, 2022 |
| | Polymer | | | | |

### Tests to Run on the Sample

| No. of | | |
|---|---|---|
| Sample | | |
| Entry | Sample | Test to run |
| 30245 | DJRA | Penetration (IRAM 6576) |
| | Polymer | Reologic properties of DSR asphaltic binder |
| | | (ASHTO T-315) |
| | | “Multiple stress creep recovery” MSCR |
| | | (ASHTO T-350) |

Analysis of certain rheological parameters of the polymer binder subject of the present disclosure.

Several tests were performed on the polymer binder. It is important to highlight that certain embodiments of the invention include or consist of an acrylic styrene polymer solution in water. Therefore, in order to evaluate the rheological properties, the water had to be first evaporated from the system.

Key tests performed include:

A penetration test was conducted on the polymer binder, and, using a Dynamic Shear Rheometer (DSR), measurements of the G*/senδ parameter were taken at different temperatures. These measurements follow the AASTHO M320/ASTM D7175 standards to determine the Performance Grade (PG) for high temperatures.

Similarly, through the DRS the Creep Compliance (Jnr) and Elastic Recovery Percentage (R) values were measured at 76° C. and for different stress levels (0.1 kPa, 3.2 kPa) used as per the AASTHO M332 standard to determine the high-temperature PG performance via this parameter (MSCR).

The results of these tests are presented below. It should be noted that other traditional tests were not conducted due to the particular nature of the polymer binder.

### Penetration Test Report

### I. Sampling, Identification, Reception and Characterization of the Sample.

Date of sample collection: ______/______/______
Sampling location: ______
Sampling procedure: See Note 1
Identification of sampling: Pure styrene acrylic polymer binder
Sampling entry date: Mar. 2, 2022

### Internal Laboratory No.:

### II. Test

Date of sample execution: Aug. 2, 2022
   a. Test conditions
Load mass: 100±0.5 g
Temperature: 25±0.1° C.
Time: 5 secs
   b. Test Results

| | DETERMINATIONS | | | Average |
|---|---|---|---|---|
| Sample | [0.1 mm] | | | [0.1 mm] |
| 1 | 8 | 10 | 9 | 9 |

IRAM 6576 Standard (for Asphalts with Penetration <200)

### Rheological Properties of the Asphalt Binder (DSR) ASSHTO T-315

### I. Sampling, Identification, Reception and Characterization of the Sample.

Date of sample collection: ______/______/______
Sampling location: ______
Sampling procedure: See Note 1
Identification of sampling: Pure styrene acrylic polymer binder
Sampling entry date: Mar. 2, 2022

### Internal Laboratory No.:

### II. Test

Date of sample execution: Jul. 11, 2022
   i. Test Conditions
Diameter of the plate: 25.00 mm
GAP: 1000 μm
Frequency: 10 rad/seg
TEST TEMPERATURES: 52 to 88° C.
   j. Test Results

| | Complex | | | Complex |
|---|---|---|---|---|
| | Module | Phase | | Viscosity |
| T | G* | Angle δ | G*/sin δ | n* |
| ° C. | kPa | ° | kPa | Pa · s |
| 58 | 60.3 | 22.0 | 161.0 | 6034.5 |
| 64 | 55.7 | 19.9 | 163.7 | 5565.3 |
| 70 | 51.5 | 19.2 | 157.0 | 5153.3 |
| 76 | 47.3 | 19.5 | 141.7 | 4734.4 |
| 82 | 43.5 | 20.5 | 124.2 | 4345.0 |
| 88 | 40.38 | 21.8 | 108.6 | 4027.5 |

The following presents part of the results obtained and compares them with the limits specified in the AASHTO M320 standard for asphalt binders in both virgin and RTFOT-aged states. It is noted that the styrene-acrylic polymer exhibits values significantly higher than the AASHTO M320 limits of 1 and 2.2 kPa for the original and aged binder states. It should be highlighted that in the case of the styrene-acrylic polymer, an RTFOT-aged state was not evaluated, and it is not necessary to do so, as this polymer is used cold and does not undergo aging like asphalt binders during the hot mix asphalt production process. See FIG. 4.

Here are the complex viscosity (η*) values measured using the Dynamic Shear Rheometer (DSR), which are then compared with typical values for conventional asphalt binders (CA30) and polymer-modified binders (AM3), also measured in the same way with the DSR. It is observed that the styrene-acrylic polymer exhibits high complex viscosities within the studied temperature range. See FIG. 5.

### Multiple Stress Creep Recovery Test

### I. Sampling, Identification, Reception and Characterization of the Sample.

Date of sample collection: ______/______/______
Sampling location: UIDI
Sampling procedure: See Note 1
Identification of sampling: Pure styrene acrylic polymer binder (without water)
Sampling entry date: Mar. 2, 2022

### Internal Laboratory No.:

### II. Test

Date of sample execution: Jul. 11, 2022
   a. Test Conditions
Diameter of the plate: 25.00 mm
GAP: 1000 μm

### Test Temperatures: 76° C.

It is important to note that this test is normally performed on the asphalt binder aged in RTFOT and at the temperature that meets the condition G/sin δ≥2.2 kPa, according to the AASHTO M320 classification. In the case of the styrene-acrylic polymer binder, it is not aged in RTFOT for the reasons mentioned earlier. Additionally, since this polymer binder shows values greater than 2.2 kPa across the entire range of temperatures studied, even at 88° C., the MSCR parameters were determined at 76° C. This is one of the highest temperatures that can be found in asphalt pavements. The goal is to observe the elastic and resistance capacity of the styrene-acrylic polymer binder at these high temperatures.

b. Test Results

| | |
|---|---|
| R_{0.1} [%] | 98.3% |
| R_{3.2} [%] | 91.2% |
| R_{diff} [%] | 7.24% |
| J_{nr 0.1} [kPa⁻¹] | 6.24e−4 kPa⁻¹ |
| J_{nr 3.2} [kPa⁻¹] | 4.48e−3 kPa⁻¹ |

These data show the high elasticity and stiffness of the binder at this temperature, even under the changes in stresses applied during the test.

### C-4) Report XXII-1198 DYNAMIC MODULE

### Internal Reception of Sample

| No. of | | | | Date | |
|---|---|---|---|---|---|
| Sample | | | | sample | Date of |
| Entry | Material | Brand | Origin | was taken | sample entry |
| 30248 | Gravel 6-19 | — | DMT S.A. | — | Mar. 2, 2022 |
| 30249 | Sand 0-6 | — | DMT S.A. | — | Mar. 2, 2022 |
| 30247 | Pebble | — | DMT S.A. | — | Mar. 2, 2022 |
| 30245 | DJRA polymer | — | DMT S.A. | — | Mar. 2, 2022 |

### Tests to Run on Sample

| No. of | | |
|---|---|---|
| sample | | |
| entry | Sample | Test to run |
| — | Mix w/ | Resilient Dynamic Module (EN 12697: 26) to |
| | styrene- | 20°X 2 hz |
| | acrylic | Resilient Dynamic Module (EN 12697: 26) at |
| | polymer | different temperatures and frequencies. |
| | | Master Curve. |

### Test Report

### Resilient Dynamic Module (En 12697:26 Standard Annex C)

### C-5) Indirect Traction as a Result of Diametral Compression (RTI)

### I. Sampling, Identification, Reception and Characterization of the Sample.

Date of sample collection: ______/______/______
Sampling location: UIDI
Sampling procedure: See Note 1
Identification of sampling: Mixture of CACD19 styrene-acrylic polymer
Sampling entry date: Feb. 3, 2022

### II. Test

Date of test execution: Jun. 19-27, 2022

In the study of this new material, styrene-acrylic polymer, cold mixes were prepared, and Marshall specimens were molded with 75 blows, which were demolished after 48 hours. It was observed that the asphalt mixture gains strength over time, similar to cold asphalt mixes, where the loss of water leads to a maturation of this strength, so to speak. A sort of curing process occurs, where the polymer becomes more prominent and the mixture gains in strength. For this reason, the curing process was evaluated through periodic measurements of dynamic modulus at 20° C. and 2 Hz frequency, in accordance with EN 12697-26 Annex C.

a. Test conditions
Temperature: 20° C.
Number of cycles: 20
Induced deformity: 5 u
Specimen diameter: 10.2 cm
Excitation time: 124 ms
Pulse repetition period: 3 secs
Rest time: 2906 ms
   b. Test Results

| Witness | TEST TUBE I |
|---|---|
| | Average |
| Thickness [cm] | 6.2 |
| Apparent density [g/cm³] | 2.49 |
| Days | Resilient Module [Mpa] |
| 2 | 2000 |
| 3 | 5733 |
| 5 | 7020 |
| 7 | 11425 |
| 8 | 12028 |
| 9 | 13136 |
| 10 | 14378 |
| 11 | 14452 |

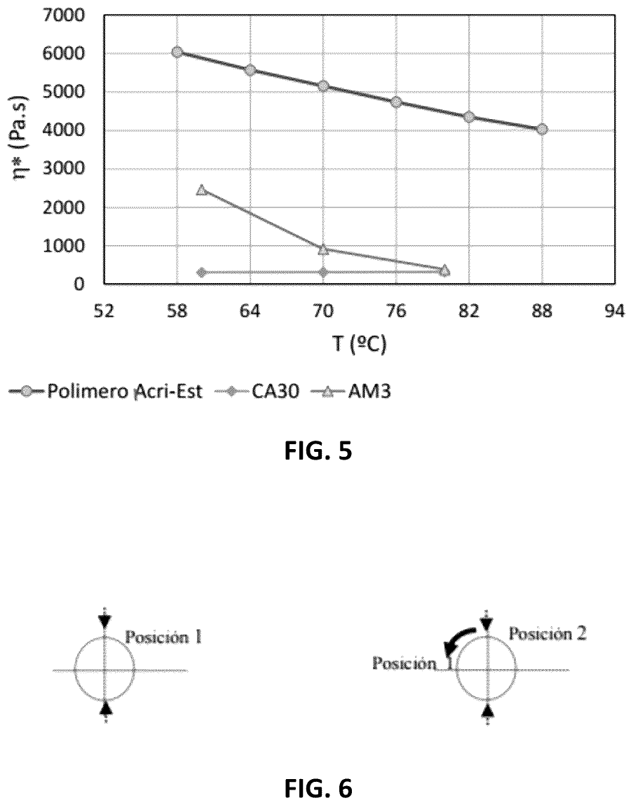

Note: The resulting values reported for each test tube correspond to the average of the determinations obtained between offset positions at 90°. See FIG. 6.

### [Position 1/Position 2]

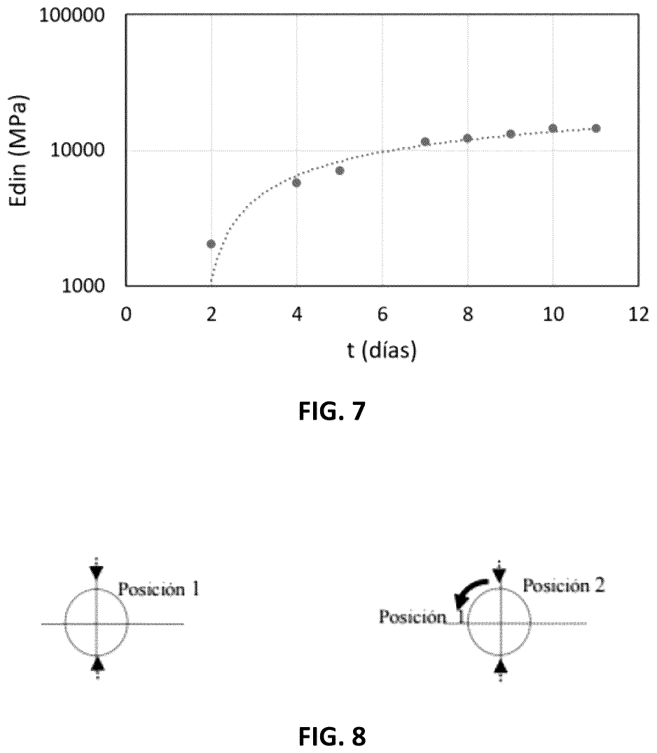

FIG. 7 is a graph showing the progression of the dynamic modulus over the days. It can be observed that from 8 to 10 days onward, the modulus tends to stabilize at a value around 14,400 MPa for this particular CAC D19 mixture with this content of styrene-acrylic polymer (4.8%). Two important aspects should be noted:
The specimens were kept curing in the thermostatically controlled forced-air chamber at 20° C. the entire time.
The percentage of styrene-acrylic polymer is not entirely polymer; the product consists of both polymer and water. The mentioned percentage of 4.8% is largely water.

Based on these observations, the mixtures for the tests conducted and upcoming ones will be “accelerated” cured in a forced-ventilation oven at 40° C.

### Dynamic Module Progression

### Construction of the Dynamic Modulus Master Curve

An important property of asphalt mixtures that influences the structural response of pavements is the dynamic modulus, or stiffness. To understand the behavior, it is common to determine what is called the dynamic modulus master curve at a reference temperature, usually 20° C. For the construction of this master curve, which is unique to each mixture, dynamic moduli were determined using diametral compression (EN 12697-26 Annex C) at different temperatures (10, 20, 30° C.) and various test frequencies (0.5, 1, 2, 4, and 10 Hz). From these tests, master curves were plotted for the mixtures, adjusted using a Sigmoidal model, and considering Arrhenius-type shift factors, as described extensively in the literature related to this topic.
TEST: Execution date of test: May 4, 2022

Considering the results of the modulus subjected to a curing process, the values presented here correspond to a set of specimens molded according to the guidelines provided by the client and then cured in a forced-ventilation chamber at 40° C. for more than 10 days prior to testing.

a. Test Conditions
Temperatures: 10, 20 and 30° C.
Number of cycles: 20 by T and f
Induced deformity: 5μ
Diameter: 10.2 cm
Excitation time:
496 ms=1.5 hz
248 ms*1 hz
124 ms=2 hz
63 ms=4 hz
50 ms=10 hz
Pulse repetition period: 3 secs
   b. Test Results

| | | Test tube | | | |
|---|---|---|---|---|---|
| | | Test Tubes | | | |
| | | E4 | ES | Prom | DS |
| Thickness [cm] | | 6.15 | 6.13 | 6.14 | 0.01 |
| Apparent density [g/cm³] | | 2.491 | 2.485 | 2.488 | 0.003 |
| Resilient Module | | | | | |
| [Mpa] − T = 10° C. | | | | | |
| 0.5 | Hz | 15103 | 17000 | 16051.5 | 948.5 |
| 2 | Hz | 15496 | 17277 | 16386.5 | 890.5 |
| 4 | Hz | 15250 | 17882 | 16565.0 | 1316.0 |
| 10 | Hz | — | — | — | |
| Resilient Module | | | | | |
| [Mpa] − T = 20° C. | | | | | |
| 0.5 | Hz | 7931 | 8670 | 8300.5 | 369.5 |
| 1 | Hz | 8945 | 9828 | 9386.5 | 441.5 |
| 2 | Hz | 9936 | 10336 | 10136.0 | 200.0 |
| 4 | Hz | 11144 | 11815 | 11479.5 | 335.5 |
| 10 | Hz | 11190 | — | 11190 | 0.0 |
| Resilient Module | | | | | |
| [Mpa] − T = 30° C. | | | | | |
| 05. | Hz | 2898 | 3609 | 3253.0 | 355.5 |
| 1 | Hz | 3285 | 4099 | 3692.0 | 407.0 |
| 2 | Hz | 3719 | 4590 | 4154.5 | 435.5 |
| 4 | Hz | 4431 | 5343 | 4887.0 | 456.0 |
| 10 | Hz | 6215 | 6769 | 6492.0 | 277.0 |

Note: The resulting values reported for each test tube correspond to the average of the determinations obtained between offset positions at 90° C. Some missing values were not considered as they seemed strange and were discarded when doing the calculations. See FIG. 8.

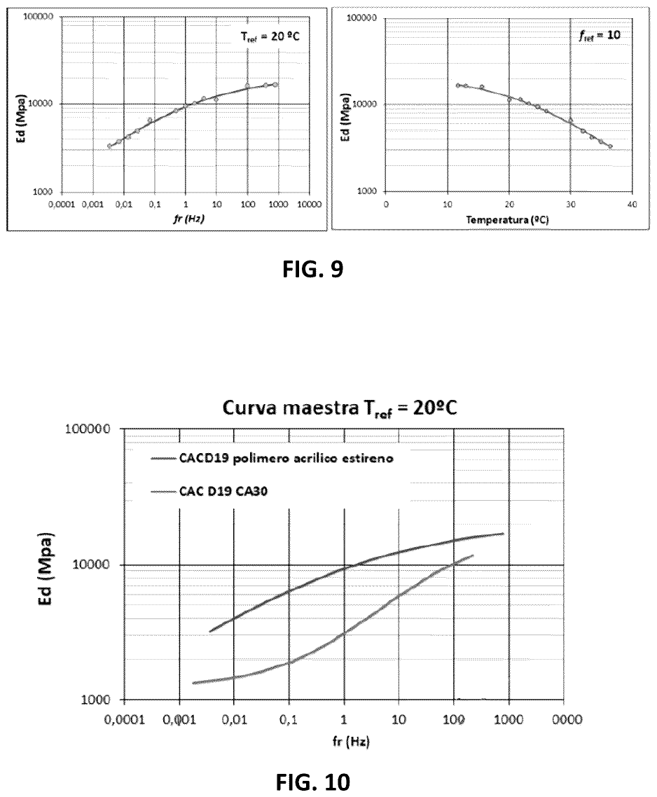

As previously mentioned, a master curve was constructed for the reference temperature of 20° C. based on these results. Additionally, a master curve Edin-T (° C.) was created for a reference frequency of 10 Hz. From these curves, it is possible to gain insight into the behavior of the studied mixture over a wide range of frequencies and/or temperatures. The curves can be observed in FIG. 9.

For comparison, FIG. 10 shows the master curve of the mixture with styrene-acrylic polymer alongside (top curve) to that of an asphalt mixture of the type CACD19 made with conventional asphalt CA30 (bottom curve).

It is contemplated that the various embodiments and features described above, including variations thereof, may be combined with one another, even if a specific combination of features is not shown in one of the accompanying figures or described in association with one particular embodiment. From the above disclosure of the general principles of the present invention and the preceding detailed description of exemplifying embodiments, those skilled in the art will readily comprehend the various modifications to which this invention is susceptible. Accordingly, this invention is intended to be limited only by the scope of the following claims and equivalents thereof.

What is claimed is:

1. A synthetic binder for use in road paving, soil stabilization, or waterproofing, comprising:
a mixture of an A-E (acrylic-styrene) copolymer with modified monomers, and an amine-type adhesion enhancer.

2. The synthetic binder of claim 1, wherein said copolymer of the A-E type (acrylic-styrene) includes between 25% and 50% of butyl acrylate (C7H12O2), between 25% and 50% of 2-ethylhexyl acrylate (C11H20O2), and from 25% to 75% of styrene (C8H8), and from 0.5% to 1.5% of acrylic acid (C3H4O2).

3. The synthetic binder of claim 1, wherein said synthetic binder is made up of 99.95% of the A-E copolymer and 0.05% of the amine adhesion enhancer.

4. The synthetic binder of claim 1, wherein the modified A-E (acrylic-styrene) copolymer has different rheological properties with varied glass transition temperatures, in a range from −25° C. to +35° C.

5. The synthetic binder of claim 1, wherein the amine-type adhesion enhancer is a solution of 0.05% Aziridine (an ethylene imine) (CH2)2NH diluted in water.

6. A method for producing a synthetic binder for use in road paving, soil stabilization, or waterproofing, comprising:
providing an A-E (acrylic-styrene) copolymer having modified monomers:
providing an amine-type adhesion enhancer; and
mixing the A-E (acrylic-styrene) copolymer having modified monomers with the amine-type adhesion enhancer to produce the synthetic binder.

7. The method of claim 6, wherein mixing the A-E (acrylic-styrene) copolymer having modified monomers with the amine-type adhesion enhancer includes mechanically mixing the A-E (acrylic-styrene) copolymer with the amine-type adhesion enhancer at room temperature between 0° C. and 50° C., with a mixing time of 3 to 5 minutes and at an agitation speed ranging from 60 rpm to 300 rpm.

8. The method of claim 6, wherein mixing the A-E copolymer having modified monomers with the amine-type adhesion enhancer includes introducing the A-E copolymer emulsified in water and the amine-type adhesion enhancer into a mixing device in a proportion of between 99% and 99.9% by weight of the A-E type copolymer emulsified in water and between 0.1% and 1% by weight of the amine-type adhesion enhancer.

9. The method of claim 6, further comprising:
emulsifying the A-E (acrylic-styrene) copolymer having modified monomers in water at 50%; and
introducing the emulsified A-E (acrylic-styrene) copolymer having modified monomers into a polymerization reactor.

10. The method of claim 6, further comprising:
providing a batch or continuous reactor;
pre-heating an A-E mixture of between 25% and 50% of butyl acrylate (C7H12O2), between 25% and 50% of 2-ethylhexyl acrylate (C11H20O2), and from 25% to 75% of styrene (C8H8), and from 0.5% to 1.5% of acrylic acid (C3H4O2) to a temperature between 60° C. and 85° C.;
emulsifying the pre-heated A-E mixture in water by the addition of a non-ionic surfactant including nonyl phenol with 10 moles (C15H24O) and KPS (potassium persulfate) as the polymerization reaction initiation agent, in a proportion of 0.01% to 0.1% of the weight of monomers;
injecting the pre-heated and emulsified A-E mixture into the batch or continuous reactor;
constantly agitating the A-E mixture in the batch or continuous reactor with an anchor stirrer, with a rotation speed between 60 rpm and 300 rpm;
maintaining the reaction for 1.5 to 3 hours;
stopping the reaction by reducing the temperature of the A-E mixture to 20° C.; and
neutralizing the emulsified mixture with sodium hydroxide (NaOH) in aqueous solution at 10%.

11. The method of claim 10, further comprising pre-heating the A-E mixture to a temperature between 70° C. and 75° C.

12. The method of claim 10, wherein constantly agitating the A-E mixture in the batch or continuous reactor includes rotating the anchor stirrer at a speed of about 150 rpm.

13. The method of claim 10, wherein the proportion of KPS (potassium persulfate) is between 0.07% and 0.1% of the weight of the monomers.

14. The method of claim 6, further comprising applying the resulting synthetic binder to one of a public road, pedestrian walkway, or decorative surface.

15. The method of claim 6, further comprising applying the resulting synthetic binder to a surface as a soil stabilizer or to waterproof that surface.
